(19) United States
(12) Patent Application Publication
(10) Pub. No.: US 2006/0129750 A1
(43) Pub. Date: Jun. 15, 2006

(54) Method and apparatus for storing multimedia data in nonvolatile storage device in units of blocks

(75) Inventors: Tae-hun Lee, Suwon-si (KR); Hyok-sung Choi, Yongin-si (KR)

Correspondence Address: SUGHRUE MION, PLLC, 2100 PENNSYLVANIA AVENUE, N.W., SUITE 800, WASHINGTON, DC, 20037, US

(73) Assignee: SAMSUNG ELECTRONICS CO., LTD.

(21) Appl. No.: 11/300,470

(22) Filed: Dec. 15, 2005

(30) Foreign Application Priority Data
Dec. 15, 2004 (KR) 10-2004-0106431

(51) Int. Cl. G06F 12/00

(52) U.S. Cl. 711/103

(57) ABSTRACT

Provided are a method and apparatus for storing multimedia data in a nonvolatile storage device in units of blocks, in which the time required for storing the multimedia data in the nonvolatile storage device can be reduced. The method includes receiving the multimedia data, sequentially storing the received multimedia data in a block in which all pages are empty among blocks included in a nonvolatile memory, and searching in the nonvolatile memory for a fragmented block in which some pages are occupied by data and moving the pages of the fragmented block that are occupied by data to another block.

### CROSS-REFERENCE TO RELATED APPLICATION

This application claims priority from Korean Patent Application No. 10-2004-0106431 filed on Dec. 15, 2004, the disclosure of which is incorporated herein in its entirety by reference.

### BACKGROUND OF THE INVENTION

1. Field of the Invention

The present invention relates to a method and apparatus for storing multimedia data in a nonvolatile storage device in units of blocks.

2. Description of the Related Art

In line with the development of multimedia technology, the amount of memory required to store a person's personal information has tended to increase. This means that the capacity of memories used in various devices must also increase. In addition, due to a variety of devices requiring storage of multimedia data, e.g., digital cameras, digital camcorders, or digital recorders, there has been growing interest in nonvolatile storage devices for storing multimedia data. One such type of nonvolatile storage device is a block access memory, which requires an erase operation before a write operation like in a NAND flash memory.

To store data in the block access memory, an erase operation should be performed first. A data unit erased in one operation is usually larger than that stored in one operation. For example, when the unit of storage is 512 bytes and the unit of erasure is 16 Kbytes, a storage operation is typically performed in units of 512 bytes. However, if a region on which the storage operation is to be performed is included in a region on which an erase operation has not been performed, the erase operation should be performed first. Thus, to write 512 bytes, 16 Kbytes should be erased before 512 bytes are written. This is because there are two states, that is, an erased state and a non-erased state, in the block access memory.

FIG. 1 illustrates a process of writing data in a conventional flash memory in units of pages.

Data can be written in a flash memory 100 in units of pages. Each page generally has a predetermined size of 512 bytes or 1024 bytes. Thus, when only a single byte is desired to be written, a storage operation has to be performed on the entire page including a region in which the single byte is to be stored. In FIG. 1, a storage region of the flash memory 100 is divided into units of pages. To write one byte of information in a page 0x0003, information stored in a memory 200 can be stored in the flash memory 100 after it is buffered to a size of one page. Since data is stored in the flash memory 100 in units of pages, the data entirely occupies one page even if the data is a smaller unit than a page. As a result, after one byte is written in a page, no further data can be stored in the page before an erase operation is performed. The memory 200 that performs buffering is a memory device that can rapidly input and output information, for example, a register.

FIG. 2 illustrates a process of erasing garbage stored in a block before storing one page of data in a conventional flash memory.

In FIG. 1, data is stored without an erase operation. However, when using a flash memory, a page in which data is to be stored may include garbage that is invalid information. The garbage indicates unnecessary information in which other data can be stored, but which is not yet erased from a memory. In the case of a flash memory, when a region in which data is to be stored includes garbage, the data should not be written over the garbage; rather, the garbage should be erased first. While FIG. 1 shows a process of writing data to a page without garbage, FIG. 2 shows a process for writing data to a page having garbage.

In FIG. 2, a flash memory 101 is divided into units of pages. A block (block A) is composed of 32 pages. A write operation and a storage operation are performed in units of pages and an erase operation is performed in units of blocks. Thus, for the erase operation, a block is entirely erased.

Each page of the flash memory 101 is in one of the three states shown in box 50. A state in which valid data is stored is indicated by 10, and a state in which garbage is stored and is not yet erased is indicated by 20. A state in which garbage is erased or data is not stored, and thus, data can be written, is indicated by 30. In the state 20 where the garbage is not yet erased, an erase operation should first be performed to write data onto a page.

The flash memory 101 includes pages 0x0001, 0x0002, 0x0003, 0x001F, and 0x8012 in which data is stored, pages 0x0000, 0x001C, 0x001D, and 0x001E in which non-erased garbage remains, and pages 0x8011 and 0x8013 in an erased state. If, for example, data is to be stored in the page 0x001C, since the page 0x001C is in a non-erased state, an erase operation should be performed to store data. However, as mentioned above, the unit of the erase operation is larger than that of the storage operation. As a result, pages 0x0000 through 0x001F of a block A should be erased in order to store data in the page 0x001C. However, since the block A includes pages in which valid data is stored, such pages should not be erased. Thus, before the block A is erased, information about the pages of the block A is copied to a memory (the buffer 200). Data to be stored in the page 0x001C is then temporarily stored in the memory 200. The pages of the block A of the flash memory 100 are erased as indicated by 102 to make pages stored in the memory available. Thereafter, since the pages of the block A are in the state 30 where data can be written, the pages stored in the memory 200 are stored. At this time, as indicated by 103, by storing only valid data pages 0x0001, 0x0002, 0x0003, 0x0001C, and 0x0001F without writing the pages having garbage, data can be stored in the other pages of the block A without an erase operation.

As shown in FIG. 2, to write a page, an entire block should be erased. Thus, when data is not entirely erased from the block, but only a portion of the data is erased and the remaining portion is stored in the memory 200, a storage operation should be performed after an erase operation, which requires a considerable time.

In the case of multimedia data, data is received in real time and a large amount of data is continuously stored. As a result, since many erase operations should be performed between storage operations, much delay is caused due to the erase operations. Therefore, a storage method that can reduce the number of erase operations is required. Moreover, since multimedia data is erased in units of files, modification or erasure may occur in units that are larger than pages.

Accordingly, there exists a need for a method for rapidly storing multimedia data in a nonvolatile storage device such as a flash memory that performs an erase operation in units of blocks.

### SUMMARY OF THE INVENTION

The present invention provides a method and apparatus for storing multimedia data in a nonvolatile storage device in units of blocks, in which the time required for storing multimedia data in a nonvolatile storage device is reduced.

The present invention also provides a method and apparatus for storing multimedia data in a nonvolatile storage device in units of blocks, in which the time required for reading multimedia data is reduced.

The above stated objects as well as other objects, features and advantages, of the present invention will become clear to those skilled in the art upon review of the following description.

According to an aspect of the present invention, there is provided a method for storing multimedia data in a nonvolatile storage device in units of blocks. The method includes receiving the multimedia data, sequentially storing the received multimedia data in a block in which every page is empty among blocks included in a nonvolatile memory, and searching in the nonvolatile memory for a fragmented block in which some pages are occupied by data and moving the pages of the fragmented block that are occupied by data to another block.

According to another aspect of the present invention, there is provided an apparatus for storing multimedia data in a nonvolatile storage device in units of blocks, the apparatus including a data receiving unit which receives the multimedia data, a storage unit which sequentially stores the received multimedia data in a block in which all pages are empty among blocks included in a nonvolatile memory, and a control unit which searches in the nonvolatile memory for a fragmented block in which some pages are occupied by data and moves the pages of the fragmented block that are occupied by data to another block.

### BRIEF DESCRIPTION OF THE DRAWINGS

The above and other features and advantages of the present invention will become more apparent by describing in detail exemplary embodiments thereof with reference to the attached drawings in which:

FIG. 1 illustrates a process of writing data in units of pages in a conventional flash memory;

FIG. 2 illustrates a process of erasing garbage stored in a block and storing one page of data in a conventional flash memory;

FIG. 3 illustrates a process of storing multimedia data in a block access memory according to an embodiment of the present invention;

FIG. 4 illustrates a process of storing non-multimedia data in a block access memory according to an embodiment of the present invention;

FIG. 5 illustrates four-state blocks according to an embodiment of the present invention;

FIG. 6 illustrates a process of storing data in a block access memory according to an embodiment of the present invention;

FIG. 7 is a flowchart illustrating a process of collecting garbage during an idle time according to an embodiment of the present invention; and

FIG. 8 is a block diagram of an apparatus for storing multimedia data in a nonvolatile storage device according to an embodiment of the present invention.

### DETAILED DESCRIPTION OF THE INVENTION

Before explaining the present invention, terms used in the specification will now be described briefly. However, it is noted that the use of any and all examples or exemplary terms provided herein is intended merely to better illuminate the invention and is not a limitation on the scope of the invention unless otherwise claimed.

Block Access Memory

A block access memory is a memory which stores information in a memory device having garbage after erasing the garbage. A NAND flash memory is an example of a block access memory. The block access memory includes a parameter random access memory (PRAM) that partially stores information even when the power is not supplied and a magnetoresistive random access memory (MRAM) that stores bits using a magnetic charge.

Flash Memory

A flash memory is a kind of electrically erasable and programmable read only memory (EEPROM) and can be classified into a NOR type that supports byte-unit input/output (I/O) operations and a NAND type that supports page-unit I/O operations. The NOR-type flash memory performs a fast read operation, but a slow write operation. On the other hand, the NAND-type flash memory performs a fast write operation and its unit cost is low, and thus it is usually used as a storage device for large-scale data. The flash memory is a nonvolatile memory and thus maintains data even when the power is not supplied. Although the present invention is described with reference to a NAND flash memory, which is a kind of block access memory, the present invention can also be applied to a memory that requires an erase operation before a storage operation.

Buffer

A memory can be classified into a nonvolatile memory and a volatile memory. The buffer in the present invention is a volatile memory, provides rapid I/O operations like a register and a RAM, and temporarily stores data. In general, a register is mounted in a flash memory to increase the speed of data I/O operations.

Storage Unit (Write or Record Operation)

A storage unit is the amount of data that is stored (written or recorded) in one write operation. In a flash memory, a storage operation is performed in units of a page. The page is set to a predetermined size, such as 512 bytes, by a memory manufacturer at the time of manufacturing.

Erase Unit

An erase unit is the amount of data that is erased in one erase operation. When the unit of an erase operation is larger than the unit of a storage operation, several units of a storage operation may constitute a single unit of an erase operation. In a flash memory, the unit of an erase operation is called a block. If, for example, the size of a block is 16 Kbytes and the size of a page is 512 bytes, the block is composed of 32 pages. The size of a block, the size of a page, and the correlation therebetween may vary with the characteristic of a memory, a manufacturer, and a memory device.

Block, Page

A memory region that is the unit of an erase operation is called a block. A memory region that is the unit of a storage operation is called a page.

State of Flash Memory

A flash memory may be in three states, i.e., a state where readable valid data is stored, an erased state where data can be stored, and a non-erased state where invalid garbage is stored and an erase operation should be first performed before a storage operation. Since the unit of an erase operation is larger than the unit of a storage operation, the erase operation should be first performed before the storage operation, resulting in overhead.

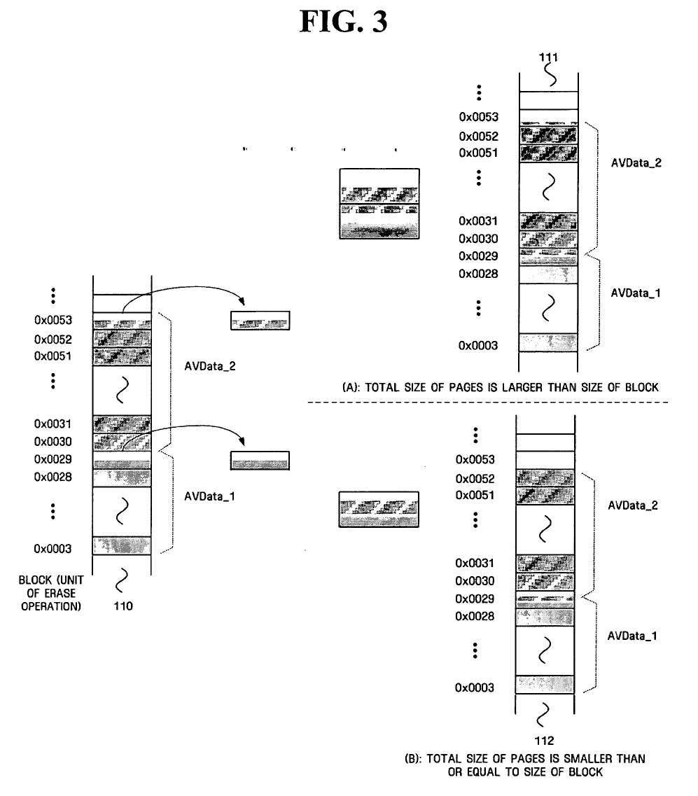

FIG. 3 illustrates a process of storing multimedia data in a block access memory according to an embodiment of the present invention.

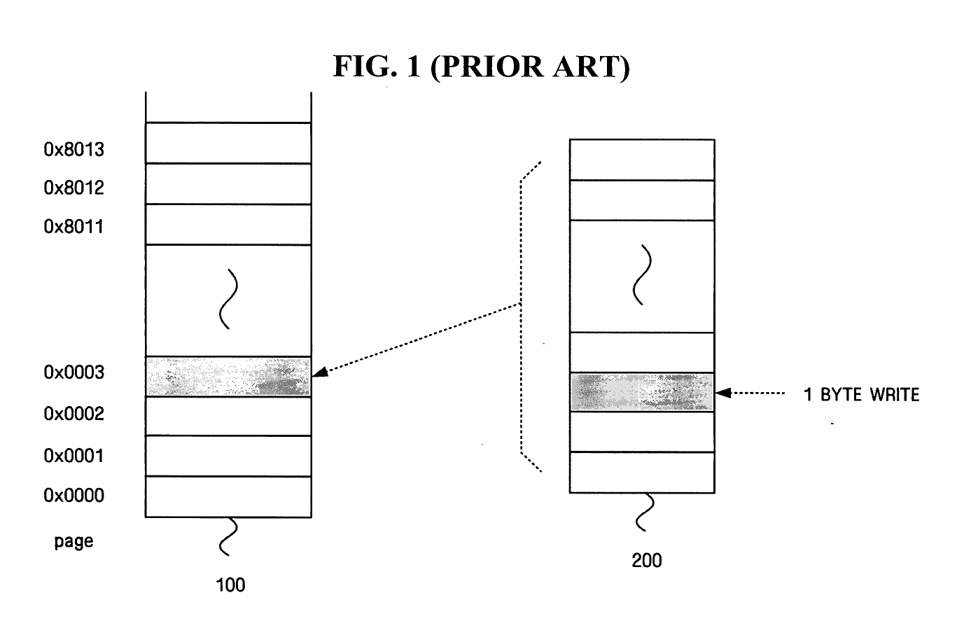

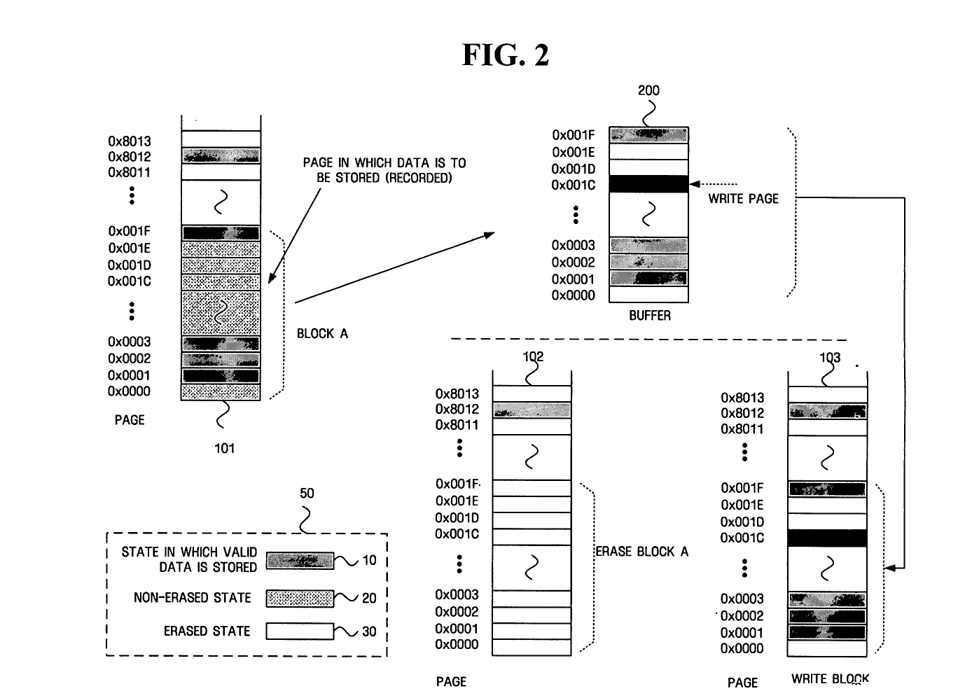

Memories 110, 111, and 112 of FIG. 3 are divided into units of blocks, unlike FIGS. 1 and 2 where a flash memory is divided into units of pages. At least two pages may be included in a single block.

A flash memory is an embodiment of a block access memory, a page indicates a memory size of the unit of a storage operation, and a block indicates a memory size of the unit of an erase operation.

As mentioned above, multimedia data is continuously stored and read. In addition, multimedia data is not usually modified. Thus, multimedia data is stored in units of blocks to reduce the time required for an erase operation before a storage operation. As an exception, the last part of multimedia data is stored in units of pages when it is smaller than the size of a block. Storing data in units of pages means storing data of all pages of a single block during a storage operation. A memory such as a flash memory usually stores data in units of pages, but data of all pages of a single block is stored to rapidly store multimedia data and prevent the increase of fragmented blocks. In addition, when there exist many blocks in which data can be stored without an erase operation, data is sequentially stored, thereby reducing delay in data I/O operations. Sequential data storage means, for example, sequentially storing data in pages of a single block.

The memory 110 of FIG. 3 is a part of a flash memory in which multimedia data AVData_1 and AVData_2 are stored in units of blocks. AVData_1 is stored in units of blocks in blocks 0x0003 through 0x0028 and the last data thereof occupies some pages of a block 0x0029 due to being smaller than the size of a block. Data can be stored in the remaining pages of the block 0x0029 without an erase operation. However, AVData_2 is not stored in the remaining pages of the block 0x0029, but is stored in blocks 0x0030 through 0x0052. The remaining data of AVData_2 is stored in a block 0x0053. After AVData_1 and AVData_2 are stored in units of blocks, there exist fragmented blocks 0x0029 and 0x0053 partially occupied by data. As the number of fragmented blocks increases, the unit of an erase operation and the unit of a storage operation are not matched with each other, resulting in the storage of multimedia data in units of blocks. Thus, such fragmented blocks should be combined. Such combination means moving and storing pages of blocks in which data is stored such that the pages entirely occupy a block.

Such combination can be classified into two cases, i.e., where the total size of pages of the fragmented blocks 0x0029 and 0x0053 in which data is stored is larger or smaller than the size of a block.

In FIG. 3, (A) shows a case where the total size of the pages of the fragmented blocks 0x0029 and 0x0053 in which data is stored is larger than the size of a block. For example, when 32 pages constitute a block, the sum of the pages of the fragmented blocks 0x0029 and 0x0053 in which data is stored is larger than 32. A part of the AVData_2 data stored in the block 0x0053 is moved to and stored in the block 0x0029. Some pages that are not copied to the block 0x0029 remain in the block 0x0053. The block 0x0029 is entirely occupied by valid data of the pages of AVData_1 and AVData_2. As a result, the number of fragmented blocks is reduced to one, that is, the fragmented block 0x0053, in which some of the valid data remains. The result of the storage is indicated by 111.

In FIG. 3, (B) shows a case where the total size of the pages of the fragmented blocks 0x0029 and 0x0053 in which data is stored is smaller than or equal to the size of a block. All data of AVData_2 stored in the block 0x0053 is moved to and stored in the block 0x0029. No valid data then exists in the block 0x0053. When the total size of the pages of the fragmented blocks 0x0029 and 0x0053 in which data is stored is equal to the size of a block, there exists no fragmented block. For example, when the number of pages of a block is 32 and the total number of pages of the blocks 0x0029 and 0x0053 in which data is stored is 32, a block is entirely occupied after the pages of the block 0x0053 are moved to the block 0x0029. This is because no valid data exists in the block 0x0053 and valid data is stored in all pages of the block 0x0029.

If the total size of the pages of the fragmented blocks 0x0029 and 0x0053 in which data is stored is smaller than the size of a block, one fragmented block exists. Since the block 0x0053 does not have valid data any more, it is not a fragmented block. Since the remaining pages of AVData_1 and AVData_2 exist in the block 0x0029, the block 0x0029 is a fragmented block. The result of the storage is indicated by 112.

When other multimedia data is stored, it is stored in units of blocks as shown in FIG. 3. If a block in which last data is stored is a fragmented block, the fragmented block and a previous fragmented block are combined.

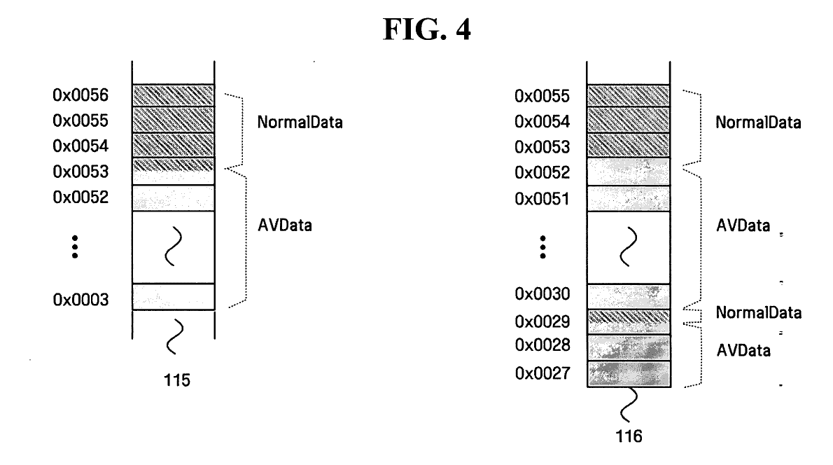

FIG. 4 illustrates a process of storing non-multimedia data in a block access memory according to an embodiment of the present invention. Memories 115 and 116 of FIG. 4 are divided into units of blocks. At least two pages may exist in a block.

Non-multimedia data is stored in units of pages, which are the units of a storage operation of a flash memory, instead of in units of blocks. Non-multimedia data is first stored in a fragmented block that may be generated when multimedia data is stored in FIG. 3. In FIG. 4, NormalData that is non-multimedia is stored. Memory 115 shows a case where NormalData is sequentially stored in units of pages when the fragmented block 0x0053 exists in the last part of NormalData is as shown in (A) of FIG. 3.

Memory 116 shows a case where NormalData is sequentially stored when the block 0x0029 existing between multimedia data is fragmented, as shown in (B) of FIG. 3.

Since some pages of the block 0x0053 are stored in the block 0x0029 in (A) of FIG. 3 and (B) of FIG. 3, some pages of the block 0x0053 exist as garbage. In this case, when NormalData is stored, NormalData may be stored after the block 0x0053 having garbage is erased or garbage may be erased after NormalData is stored in the block 0x0053 having garbage. Since real-time storage is not important in non-multimedia data, the non-multimedia data do not have to be stored in units of blocks.

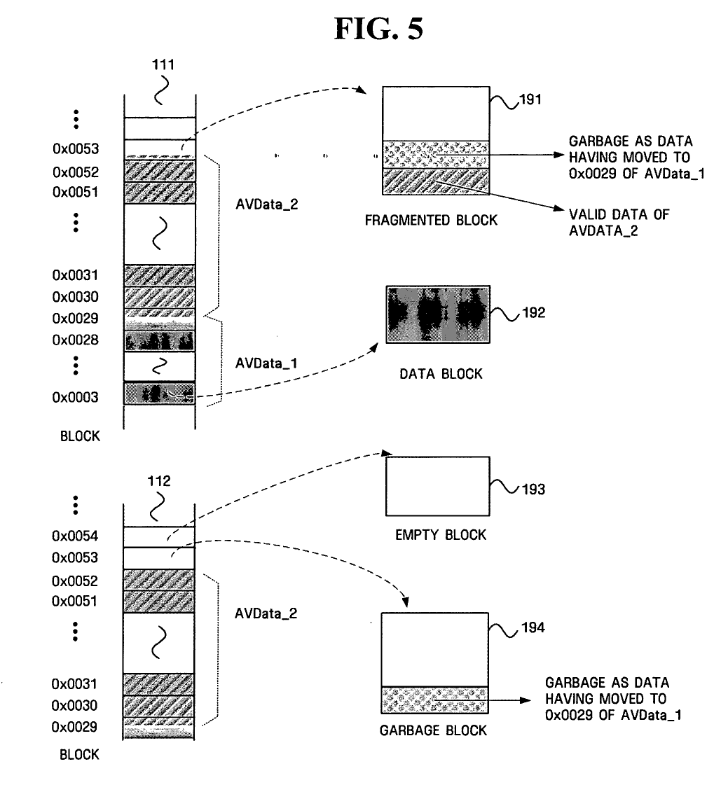

FIG. 5 illustrates four-state blocks according to an embodiment of the present invention. The four-state blocks include a fragmented block 191, a full data block 192, an empty block 193, and a garbage block 194. The flash memories 111 and 112 of FIG. 5 are the same as shown in (A) of FIG. 3) and (B) of FIG. 3. The flash memories 111 and 112 are divided into units of blocks.

Valid data is partially stored in the fragmented block 191 as in the block 0x0053 of 111 of FIG. 3. Here, the fragmented block 191 indicates a block in which garbage and valid data are stored or only valid data is partially stored. Valid data entirely occupies the data block 192 like the block 0x0003.

The data block 192 indicates a block in which only valid data is stored, no garbage exists, and an empty page in which data can be stored does not exist. The empty block 193 means a block in which data is not stored and no garbage exists.

Thus, the empty block 193 does not require an erase operation for a storage operation like the block 0x0053 of 112 of FIG. 3.

The garbage block 194 means a block having garbage. The garbage block 194 may be a block partly occupied by garbage like the block 0x0053 of 112 of FIG. 3 or a block that is entirely occupied by garbage. If some pages including valid data exist and some pages including garbage exist, such a block is regarded as a fragmented block, instead of a garbage block.

The four states can be expressed using 2 bits. When the number of states of the blocks is greater than 4, the states can be expressed using more than 2 bits. When it is only necessary to indicate whether data is stored or not or the four states do not exist, for example in a garbage collecting method, only 1 bit can be used.

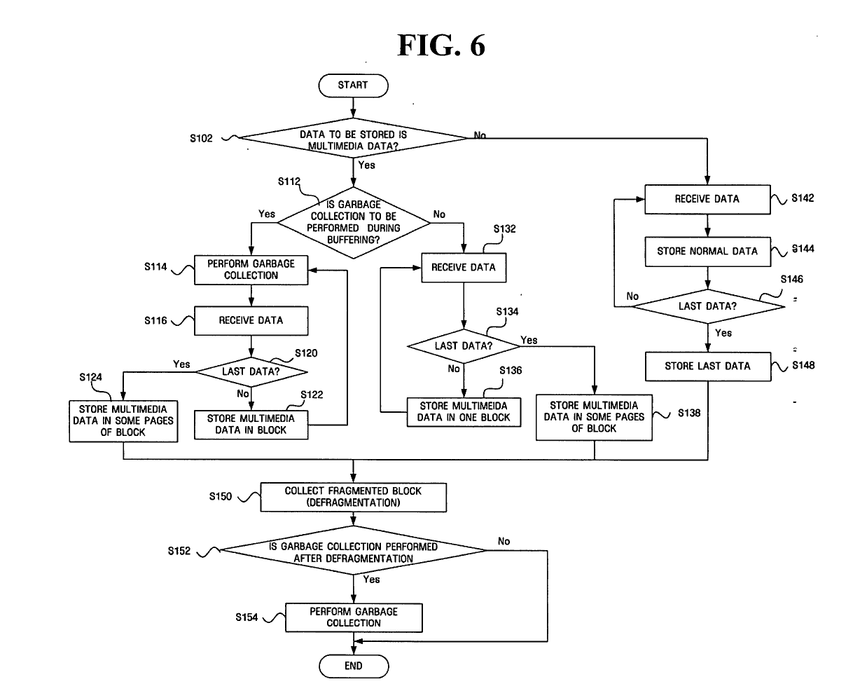

FIG. 6 illustrates a process of storing data in a block access memory according to an embodiment of the present invention. The process shown in FIG. 6 is based on two garbage collection schemes, i.e., one in which garbage is collected during buffering and another in which garbage is collected after a fragment collecting operation which involves collecting fragmented blocks after data is stored.

Since a storage method varies according to whether data to be stored is multimedia data or non-multimedia data, it is determined whether received data is multimedia data in step S102. If the received data is multimedia data, a current garbage collection scheme is checked. If it is determined that garbage collection is to be performed during buffering in step S112, garbage collection is performed in step S114. Garbage collection means changing a garbage block into an empty block in which data can be stored. In step S116, garbage collection may be performed while multimedia data is being received. Thus, garbage is collected while the multimedia data is being received and buffered (temporarily stored) in a temporary storage unit, thereby preventing or reducing delay. If it is determined that the received multimedia data is not the last data of single multimedia content in step S120, the received multimedia data can occupy a single block and thus the received multimedia data is stored in a block in step S122. The block is an empty block in which garbage is erased through garbage collection in step S114. Steps S114 through S122 are repeated until multimedia content is entirely received. Multimedia data constituting a last portion of the multimedia content is received. If the size of the multimedia data is the same as the size of a block, the received multimedia data is stored in a block. If the size of the multimedia data is smaller than the size of a block, the received multimedia data is stored in units of pages in step S124. Such a block is a fragmented block which has some pages occupied by data.

If it is determined that garbage collection is not performed during buffering in step S112, data is received and stored. Thus, multimedia data is received in step S132. The received multimedia data may be buffered in a temporary storage unit such as a register. This is because specific data can be received and stored in units of blocks or pages. If it is determined that the received multimedia data is not last data of single multimedia content in step S134, the multimedia data can entirely occupy a single block. Thus, the received multimedia data is stored in a block in step S136. Such a block is an empty block having no garbage. Steps S132 through S136 are performed until multimedia is entirely received. Multimedia data constituting a last portion of the multimedia content is received. If the size of the multimedia data is the same as the size of a block, the received multimedia data is stored in a block. If the size of the multimedia data is smaller than the size of a block, the received multimedia data is stored in units of pages in step S138. Such a block which has some pages occupied by data is a fragmented block.

If it is determined that data to be received in step S102 is non-multimedia data, the data is received in step S142 and the received data is stored in units of pages or blocks in step S144. The reception of the data in step S142 may be buffering data in a temporary storage unit. If it is determined that the received data is not last data in step S146, a process returns to step S142 to receive data. If it is determined that the received data is last data in step S146, it is stored in units of pages in step S148.

After steps S124, S138, and S148 of storing data are completed, an operation for collecting fragmented blocks is performed in step S150. The operation means combining at least two fragmented blocks or data of fragmented blocks into a block.

A fragmented block means a block which is not entirely occupied by data, i.e., a block in which only some pages are occupied by data. Combination of data of fragmented blocks means storing the data stored in some pages of the fragmented blocks in pages of a single block.

When it is determined in step S152 that a garbage collection scheme is that garbage collection should be performed after defragmentation which means fragmented block collection, the garbage is first collected in step S154.

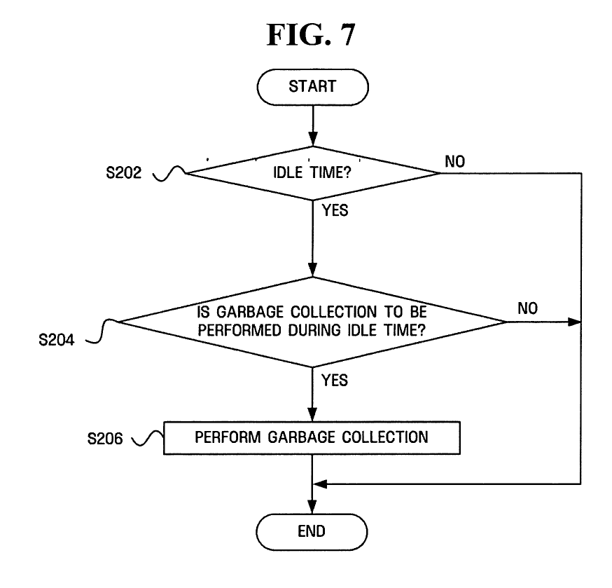

FIG. 7 is a flowchart illustrating a process of collecting garbage during an idle time according to an embodiment of the present invention.

The idle time means a period during which a read or write operation is not performed on a memory. In this case, because there is no I/O of the memory, garbage collection does not have an influence on the I/O speed of the memory. Once the memory enters the idle time in step S202, a garbage collection scheme is checked in step S204. If the garbage collection scheme is that garbage collection should be performed during the idle time, garbage collection is performed in step S206. Once an I/O command of the memory is received during garbage collection, ongoing garbage collection may be stopped.

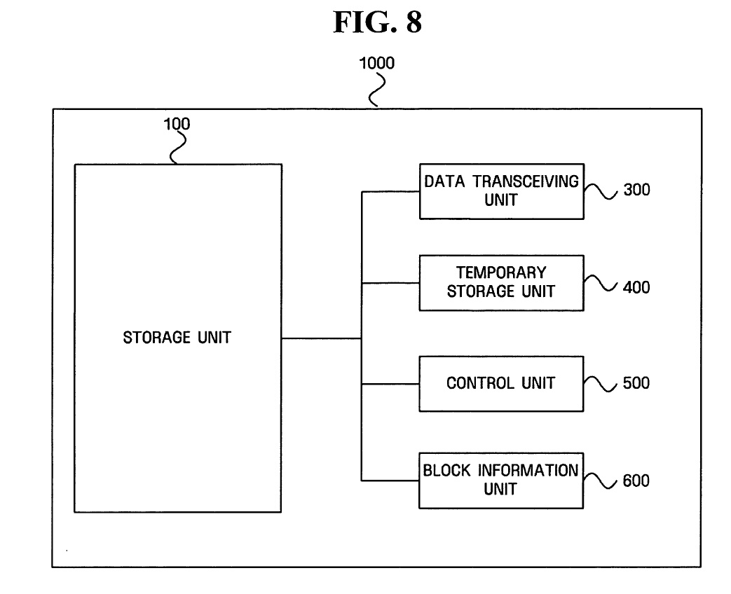

FIG. 8 is a block diagram of an apparatus for storing multimedia data in a nonvolatile storage device according to an embodiment of the present invention.

The term ‘unit’, that is, ‘module’ or ‘table’, as used herein, means, but is not limited to, a software or hardware component, such as a Field Programmable Gate Array (FPGA) or Application Specific Integrated Circuit (ASIC), which performs certain tasks. A module may advantageously be configured to reside on the addressable storage medium and configured to execute on one or more processors. Thus, a module may include, by way of example, components, such as software components, object-oriented software components, class components and task components, processes, functions, attributes, procedures, subroutines, segments of program code, drivers, firmware, microcode, circuitry, data, databases, data structures, tables, arrays, and variables. The functionality provided for in the components and modules may be combined into fewer components and modules or further separated into additional components and modules. In addition, the components and modules may be implemented such that they are executed on one or more computers in a communication system.

An apparatus 1000 for storing multimedia data in a nonvolatile storage device includes a block access memory such as a flash memory, a PRAM, or an MRAM that accesses blocks as a storage unit 100. The storage unit 100 is a memory device in which data is stored. As mentioned above, data is stored in the storage unit 100 in units of pages and data is erased in units of blocks. A block includes at least two pages. When multimedia data is stored in the storage unit 100, the multimedia data is stored in units of blocks. The multimedia data may be exceptionally stored in units of pages only when it is last data.

A data transceiving unit 300 transmits and receives data and receives a control command from another device or transmits data stored in the storage unit 100.

A temporary storage unit 400 exists between the storage unit 100 and the data transceiving unit 300 to improve the speed of a data read or write operation. The temporary storage unit 400 is usually a volatile memory such as a register or a RAM. The temporary storage unit 400 is different from the buffer 200 of FIGS. 1 and 2. The buffer 200 of FIGS. 1 and 2 may be mounted in a storage device or an external device that transmits data to and receives data from the storage device.

A control unit 500 controls the storage unit 100 to store data in the storage unit 100 in units of blocks. The control unit 500 also erases garbage of the storing unit 100. The control unit 500 may check the state of each block to erase garbage. Thereafter, the control unit 500 buffers multimedia data in the temporary storage unit 400 before the storage unit 100 stores the same, and then erases garbage and stores the buffered multimedia data in the storage unit 100.

A block information unit 600 provides information about whether a block is a garbage block, an empty block, a data block, or a fragmented block. When data is stored in or erased from the storage unit 100, the control unit 500 may control the block information unit 600 such that a change in a block can be reflected in the block information unit 600.

According to the present invention, it is possible to reduce the time required for storing multimedia data in and reading multimedia data from a non-volatile storage device.

It will be apparent to those skilled in the art that various modifications and changes may be made thereto without departing from the scope and spirit of the invention. Therefore, it should be understood that the above embodiment is not restrictive but illustrative in all aspects. The scope of the present invention is defined by the appended claims rather than the detailed description of the invention. All modifications and changes derived from the scope and spirit of the claims and equivalents thereof should be construed to be included in the scope of the present invention.

What is claimed is:

1. A method for storing multimedia data in a nonvolatile storage device in units of blocks, the method comprising:
receiving the multimedia data;
sequentially storing the received multimedia data in a block in which all pages are empty among blocks included in a nonvolatile memory; and
searching in the nonvolatile memory for a fragmented block in which some pages are occupied by data and moving the pages of the fragmented block that are occupied by data to another block.

2. The method of claim 1, wherein the block is a region of the nonvolatile memory in which data can be erased in one operation and includes at least two pages, and a page is a region of the nonvolatile memory in which data can be stored in one operation.

3. The method of claim 1, wherein the block in which all pages are empty does not include a page in which garbage that is invalid data is stored.

4. The method of claim 1, wherein the step of sequentially storing the received multimedia data comprises storing a first portion of the multimedia data in all pages of a predetermined block and storing a second portion of the multimedia data in some of the pages of another block, if the size of the multimedia data is larger than the block size.

5. The method of claim 4, wherein the block in which the second portion of the multimedia data is stored is logically or physically adjacent to the predetermined block in which the first portion of the multimedia data is stored.

6. The method of claim 1, wherein the nonvolatile memory is one of a flash memory, a parameter random access memory (PRAM), and a magnetoresistive random access memory (MRAM).

7. The method of claim 1, further comprising erasing garbage from a block of the nonvolatile memory having a page in which garbage is stored.

8. The method of claim 1, further comprising temporarily storing the multimedia data in a volatile memory after receiving the multimedia data.

9. The method of claim 1, further comprising:
receiving non-multimedia data;
storing the received non-multimedia data in a block in which some pages are empty among blocks included in a nonvolatile memory; and
searching in the nonvolatile memory for a fragmented block in which some pages are occupied by data and moving the pages of the fragmented block that are occupied by data to another block.

10. An apparatus for storing multimedia data in a nonvolatile storage device in units of blocks, the apparatus comprising:
a data receiving unit which receives the multimedia data;
a storage unit which sequentially stores the received multimedia data in a block in which all pages are empty among blocks included in a nonvolatile memory; and
a control unit which searches in the nonvolatile memory for a fragmented block in which some pages are occupied by data and moves the pages of the fragmented block that are occupied by data to another block.

11. The apparatus of claim 10, wherein the block is a region of the nonvolatile memory in which data can be erased in one operation and includes at least two pages, and a page is a region of the nonvolatile memory in which data can be stored in one operation.

12. The apparatus of claim 10, wherein the block in which all pages are empty does not include a page in which garbage that is invalid data is stored.

13. The apparatus of claim 10, wherein the storing unit stores a first portion of the multimedia data in all pages of a predetermined block and stores a second portion of the multimedia data in some pages of another block, if the size of the multimedia data is larger than the block size.

14. The apparatus of claim 13, wherein the block in which the second portion of the multimedia data is stored is logically or physically adjacent to the predetermined block in which the first portion of the multimedia data is stored.

15. The apparatus of claim 10, wherein the storage unit includes one of a flash memory, a parameter random access memory (PRAM), and a magnetoresistive random access memory (MRAM).

16. The apparatus of claim 10, wherein the storing unit erases garbage from a block of the nonvolatile memory having a page in which garbage is stored.

17. The apparatus of claim 10, further comprising a temporary storage unit which temporarily stores the multimedia data in a volatile memory after receiving the multimedia data.

18. The apparatus of claim 10, wherein the data receiving unit receives non-multimedia data, the storage unit stores the received non-multimedia data in a block in which some pages are empty among blocks included in a nonvolatile memory, and the control unit searches in the nonvolatile memory for a fragmented block in which some pages are occupied by data and moves the pages of the fragmented block that are occupied by data to another block.
